(19) United States
(12) Patent Application Publication
(10) Pub. No.: US 2022/0072846 A1
(43) Pub. Date: Mar. 10, 2022

(54) PLATEN

(71) Applicant: Hewlett-Packard Development Company, L.P., Spring, TX (US)

(72) Inventors: Pablo Arteaga del Arco, Sant Cugat del Valles (ES); Martin Urrutia Nebreda, Sant Cugat del Valles (ES); David Melero Cazorla, Sant Cugat del Valles (ES); Carles Flotats Villagrasa, Sant Cugat del Valles (ES)

(73) Assignee: Hewlett-Packard Development Company, L.P., Spring, TX (US)

(21) Appl. No.: 17/417,688

(22) PCT Filed: May 30, 2019
(86) PCT No.: PCT/US2019/034504

§ 371 Date: Jun. 23, 2021

(51) Int. Cl. B41F 27/12; B41N 1/00

(52) U.S. Cl. CPC B41F 27/1268; B41N 1/00

(57) ABSTRACT

A platen having a first dimension and a second dimension. The first dimension is perpendicular to the second dimension. The platen has two opposing long edges along the first dimension and two opposing short edges along the second dimension. The platen has a higher stiffness in the direction of the second dimension than in the direction of the first dimension. Each of the two opposing long edges has at least three biased attaching members spaced therealong to bias the platen towards a structural support.

Print zone system requirements may have narrow tolerances in terms of flatness in order to achieve high image quality. Further, there is a global tendency to reduce manufacturing complexity (and thereby reduce manufacturing time and cost), while increasing the performance (e.g. quality of printing) and the size of the print zones. Structural sheet metal beams may be used in printing assemblies to provide straightness directly from the manufacturing process. Parts may be required to support and flatten the print media (e.g. paper). These parts may be called platens.

There is therefore a need in the art for a solution to the requirement for printer platens which allow for both improved manufacture and reliable use to achieve high print quality.

Examples disclosed here may provide a print platen that can adapt to an (e.g. flat) structural beam shape, while minimizing tolerance errors (to obtain reliable high print quality), and minimize manufacturing process variability effects (for improved print quality and improved manufacture).

Example implementations will now be described with reference to the accompanying drawings in which:

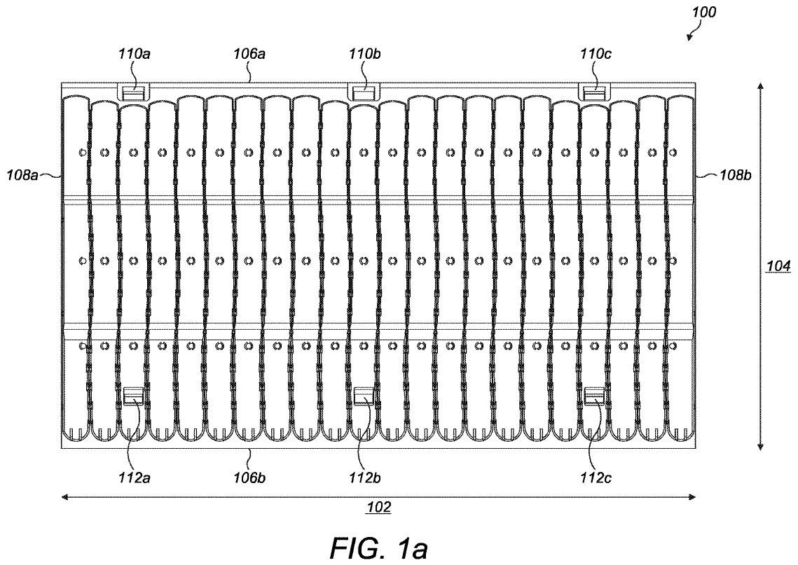

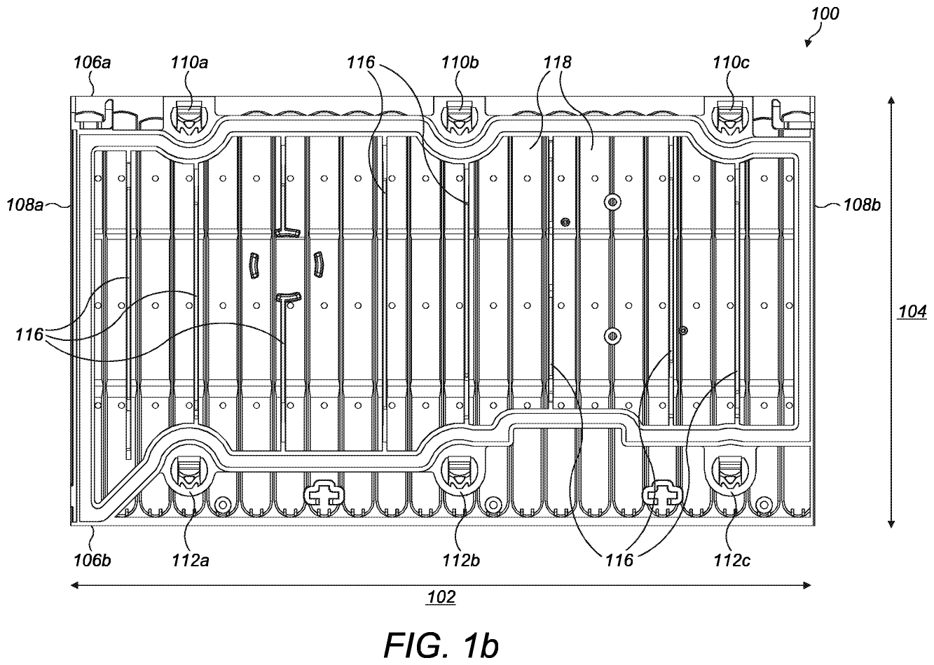

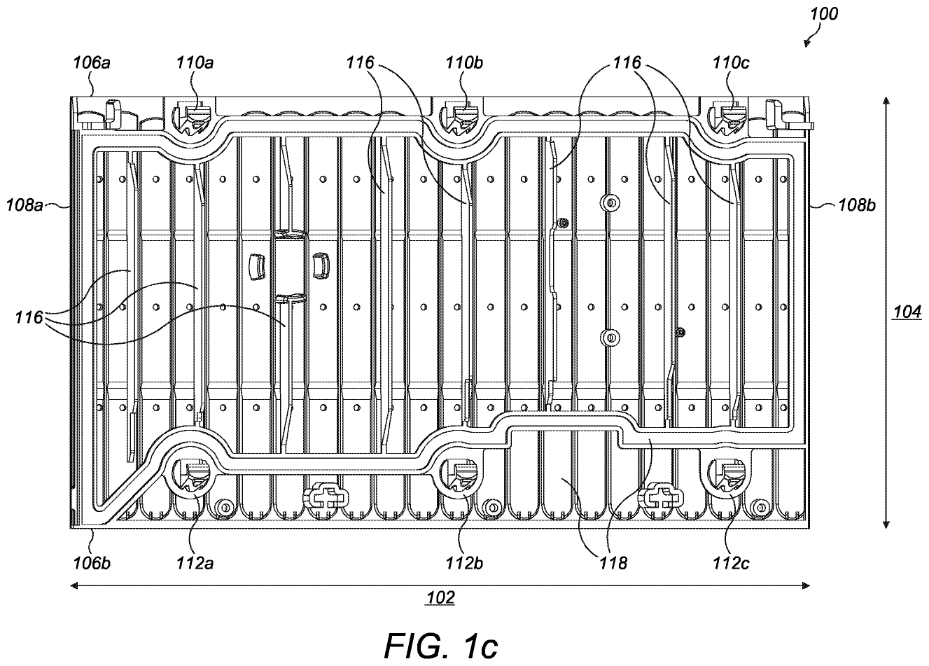

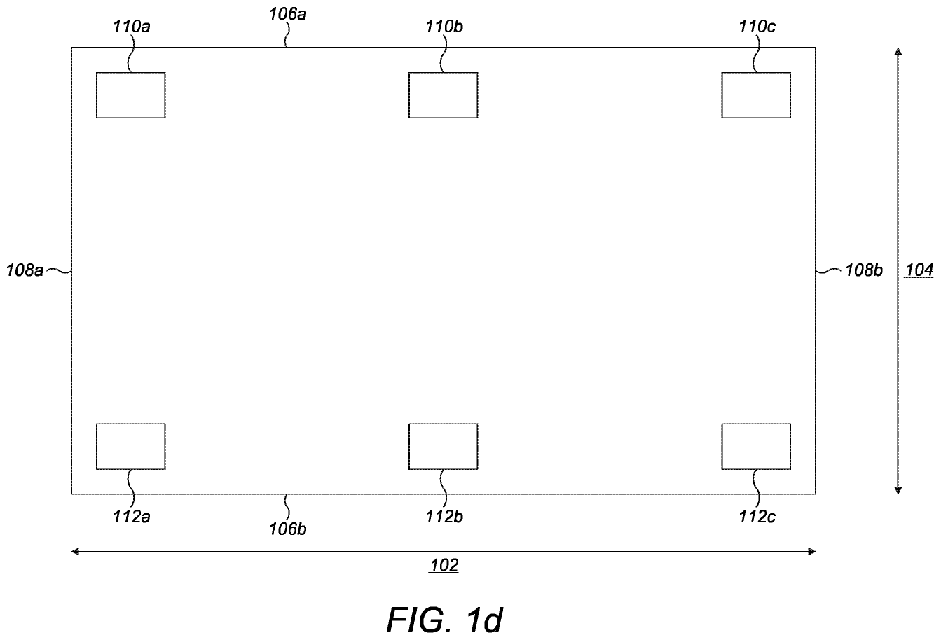

FIGS. 1a, 1b, 1c and 1d show top, bottom, bottom perspective, and schematic views respectively of a platen according to example implementations;

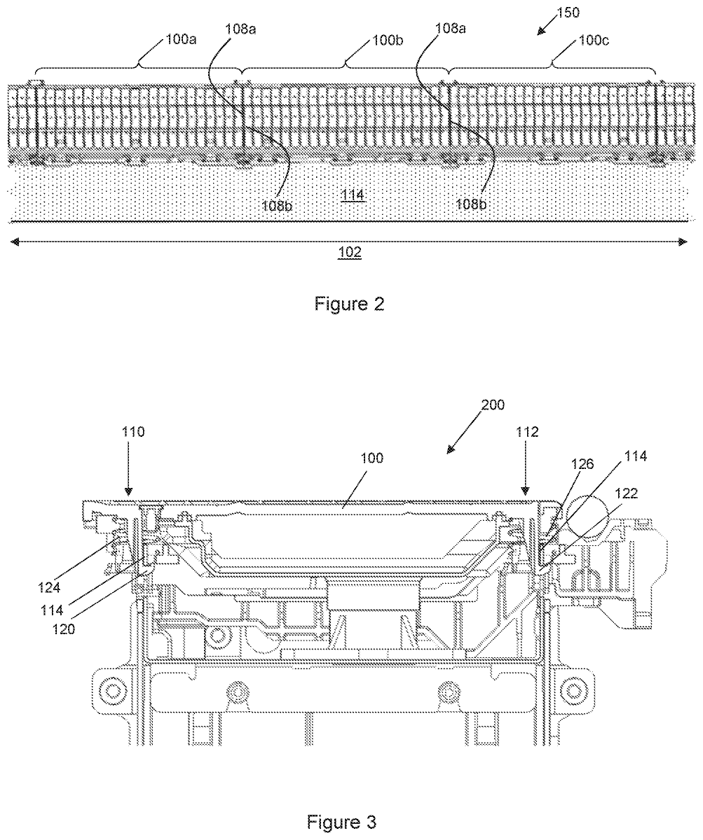

FIG. 2 shows a number of platens on a structural beam according to example implementations;

FIG. 3 shows a platen installed in a printer according to example implementations;

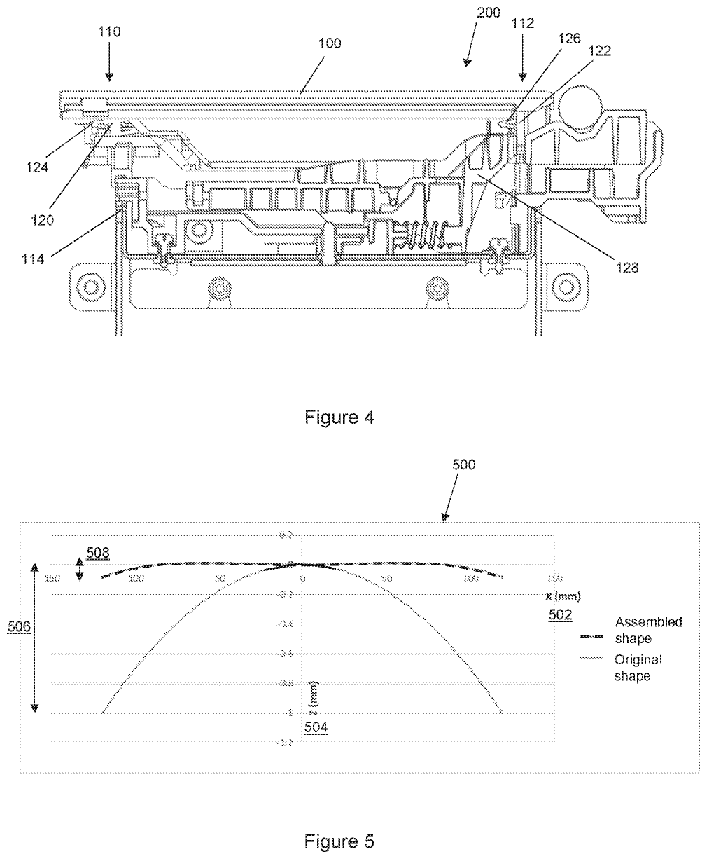

FIG. 4 shows a platen installed in a printer with a locking mechanism according to example implementations; and

FIG. 5 shows a calculated deformation of a platen according to example implementations.

Traditional methods for achieving the required high flatness specifications of printing assemblies may require complex manufacturing and require several different manufacturing stages to obtain a final printer or printing assembly. Current platens may not be able to meet the required flatness specification by existing manufacturing processes. Also, manufacturing process variability may not allow the production of a platen having a reliable specification (e.g. flatness, flexibility) during the product life cycle if the platen is left in its natural shape.

In examples disclosed herein, platen installation in a printer may be achieved without using separate screws or other separate fixing elements, because the platen may be installed using attaching members (such as hooks) along the platen long edges which act to bias the platen against a sheet metal beam or similar. Printer systems using screws or similar separate fittings to install the platen may require the sheet metal beam with a platen support part to be machined to achieve a specified flatness before platen installation. Removing the use of separate screw fittings may provide for improved accuracy of printing, because the need for separate machining to achieve flatness is removed, as well as allowing for user installation and removal/replacement of the platen.

Examples disclosed herein may not require the structural (e.g. metal, e.g. aluminum) beam to be machined to achieve a specified flatness prior to platen installation. Machining the structural beam allows for vacuum in the print zone, which examples disclosed herein also allow for. This is due to the lower stiffness of the platen in the long (e.g. carriage) direction, which allows for the platen to conform to the flat shape of the metal beam. Stiffness of a beam may be defined as the product of Young modulus and second moment of inertia (i.e. the second moment of area) of the profile of the beam. Such stiffness of a beam (e.g. the platen) may also be called the bending stiffness, or the flexural rigidity, of the beam.

Examples disclosed herein may not require the platen to be manufactured to achieve a high flatness specification, such that it is not deformed during printer assembly, with screw installation required to allow the printer to operate without vacuum. Examples disclosed herein provide for a platen which has different stiffness in the long (e.g. carriage) and short (e.g. media path) directions to prevent unwanted deformations in the platen (e.g. bowing, twisting) and allow for printing without vacuum. That is, platens disclosed herein may be used in printers which operate both with and without vacuum hold-down of the print media.

Referring to FIGS. 1a-1d, there are shown top, bottom, bottom perspective, and schematic views respectively of a platen 100 according to example implementations. The platen 100 has a first dimension 102 and a second dimension 104. The first dimension 102 is perpendicular to the second dimension 104. The platen 100 has two opposing long edges 106a, 106b along the first dimension 102 and two opposing short edges 108a, 108b along the second dimension 104.

The first dimension 102 may be in a carriage direction. The second dimension 104 may be in a media transport path direction. The first dimension may also be called the first direction or carriage direction. The second dimension may also be called the second direction or media path direction.

The platen 100 has a higher stiffness in the direction of the second dimension 104 than in the direction of the first dimension 102. Each of the two opposing long edges 106a, 106b has at least three biased attaching members 110a, 110b, 110c, 112a, 112b, 112c spaced therealong to bias the platen 100 towards a structural support. The structural support may be a structural beam in a printer, for example.

In some examples the at least three biased attaching members 110a, 110b, 110c, 112a, 112b, 112c may be spaced along the long edges 106a, 106b towards the respective edge of the platen, i.e. within a band, along and adjacent to each long edge 106a, 106b of the platen, of e.g. 5%, 10%, 15%, or more than 15%, of the total width of the platen along the short dimension 104. In some examples the at least three biased attaching members 110a, 110b, 110c, 112a, 112b, 112c may be spaced along the respective long edges 106a, 106b of the platen, wherein “along” may be taken to mean the at least three biased attaching members 110a, 110b, 110c, 112a, 112b, 112c of each long edge 106a, 106b are located between a central longitudinal axis of the platen and each respective long edge 106a, 106b of the platen (i.e. at least offset from a central longitudinal axis of the platen).

In some examples, the at least three biased attaching members 110a, 110b, 110c along a first long edge 106a of the platen 100 may be located as far from the first long edge 106a as the at least three biased attaching members 112a, 112b, 112c along a second long edge 106b are located from the second long edge 106b, as shown in FIG. 1d. In some examples, the at least three biased attaching members 110a, 110b, 110c along a first long edge 106a of the platen 100 may be located closer to the first long edge 106a than the at least three biased attaching members 112a, 112b, 112c along a second long edge 106b are located from the second long edge 106b. This latter example can be seen in figures ia, 1b and 1c. In some examples the at least three biased attaching members 110a, 110b, 110c, 112a, 112b, 112c may not all be co-linear along an axis parallel to the long edges 106a, 106b of the platen 100 (e.g. one or more of the at least three biased attaching members along a long edge 106a, 106b may be located closer to that long edge 106a, 106b than the other(s) of the biased attaching members).

It can be seen in FIGS. 1b and 1c that the platen 100 comprises a number of ribs 116 extending along the second dimension 104. The number of ribs 116 in some examples may be formed from platen material. Such ribs 116 thus provide an increased thickness of platen material perpendicular to the first and second dimensions 102, 104 compared to the platen thickness without a rib 118. The increased thickness of platen material forming the ribs 116 provide increased stiffness of the platen 100 in the short dimension 104 compared with the long dimension 102. In some examples, the number of ribs 116 may be formed from strips of stiffening material fixed to or within the platen 100. For example, metal ribs may be attached to the surface of the platen. As another example, stiff ribs may be inserted into the body of the platen. Again, such rib strips act to increase the stiffness of the platen 100 in the short dimension 104 compared with the long dimension 102. Example platens with additional rib strips to increase the stiffness in the short dimension compared to the long dimension of the platen may have a uniform platen thickness within the body of the platen (i.e. with the expectation of the protruding biased attaching members 110a, 110b, 110c, 112a, 112b, 112c). In such examples the rib strips have a higher stiffness long the short dimension of the plated compared with a material from which the remainder of the platen (at least the platen body) is formed.

The shape of the platen 100 is controlled to deform the platen 100 so that it conforms to the beam profile. This deformation is achieved by biasing the platen 100 towards the beam. The platen 100 in this example is secured with sprung hook shapes 110a, 110b, 110c, 112a, 112b, 112c biased against a flat reference in the beam. Each spring in this example provides a biasing member, and acts to directly apply force into its corresponding hook to reduce local bending deformations in the platen (e.g. bowing along the long dimension 102 of the platen 100).

In this example three hooks are located at each long edge 106a, 106b of the platen 100 to attach the platen in a printer. The hooks are biased using a spring to pull the platen towards the beam. At least three pairs of hooks 120, 122 are used (where a pair of hooks 120, 122 is a first hook 120 on one long edge of the platen and a second hook 122 on the opposite long edge 106a, 106b of the platen 100, the first and second hooks 120, 122 aligned along the short dimension 104 (e.g. media path direction) of the platen 100) to ensure the platen 100 conforms to the beam profile along the length of the platen 100.

In other examples the attaching members may not be hooks, and may take any suitable shape (e.g. a T-shape, a ball-shape, a wider portion at the free end of the attaching member) to attach the platen 100 in the printer so that it can be biased towards the beam. In other examples there may be more than three attaching members 120, 122 along each long edge 106a, 106b of the platen 100. In other examples, there may be a different number of attaching members 120, 122 along a first long edge 106a of the platen 100 than along a second opposing long edge 106b of the platen 100. In some examples, such that that shown in FIGS. 1a-1d, the attaching members 120, 122 may be located in pairs substantially opposite each other at opposing long edges 106a, 106b of the platen 100. In other examples the attaching members 120, 122 may not be located in such opposing pairs, and e.g. may be staggered along one long edge 106a compared with the opposing long edge 106b of the platen 100.

It is desirable to deform the platen 100 along the long (e.g. carriage) dimension so that it conforms to the structural beam profile with a high degree of flatness, but avoid deformation of the platen perpendicular to the long dimension (e.g. along the media path direction) to allow for the print media to pass through the printer in a controlled and accurate manner. These characteristics are desirable to provide a high quality of printing (e.g. high accuracy of dot placement/low dot placement error). To provide for platen deformation along the long dimension and reduce deformation in the short dimension, the stiffness along the second dimension 104 of a platen 100 may be at least five times greater than the stiffness along the first dimension 102 of the platen 100. Such relative stiffnesses in the long and short dimensions 102, 104 respectively may help to ensure the deformation is produced in the long dimension 102 and minimized in the short dimension 104 of the platen 100. In some examples the platen may be made of an elastic material (i.e. is reversibly deformable within a predetermined range of deformation), such as plastic, aluminum, metal, or a composite material.

To achieve the goal of 0.1 mm flatness for the platen, with 2.25 mm/m bow, the platen stiffness in some examples may not exceed 48 Nm². This stiffness allows the assembly forces to be maintained under 300 N. Under these conditions, platen stiffness in the short dimension may be at least 240 Nm².

In some examples, each platen 100 (platen module) may be 9.35″ (237.5 mm) wide. That is, the platen 100 may have a dimension between the two opposing short edges 108a, 108b of 237.5 mm (9.35″). This width allows for construction of a multi-platen 150, such that that shown in FIG. 2, to be built in a modular way, providing print zones suitable for 18″ (457.2 mm), 27″ (685.8 mm), 36″ (914.4 mm), 44″ (1117.6 mm), 54″ (1371.6 mm), 64″ (1625.5 mm) (and higher than 64″ (1625.5 mm)) medias, for example. These example sizes represent commonly used sizes in the market. The print zone may be defined as the region or area of a printer through which print media travels, or is positioned, for printing. For example, to print on paper which is 900 mm wide, a print zone at least 900 mm wide is required to allow the paper to pass through the printer.

FIG. 2 shows a number of platens 100 forming a multi-platen 150 on a structural beam 114 according to example implementations. The multi-platen 150 may be called a platen assembly. The plurality of platens 100 are arranged, with a short edge 108a of a first of the plurality of platens 100a abutting a short edge 108b of a further of the plurality of the plurality of platens 100b, along the first dimension 102. In some examples, multi-platens 150 may be formed by joining platens 100 (platen modules) together. In some examples the platens of the multi-platen may not necessarily be joined together e.g. at their short edges. The print zone in this example has a series of different platens 100 (which in this multi-platen 150 example may each be called a platen module) on top of a structural beam 114 (e.g. a closed-profile sheet metal beam.

In some examples, a platen or multi-platen may be joined to an additional part, for example, to a vacuum chamber. The joining may be achieved, for example, by means of welding or adhesive. Joining the platen to an additional part may be used for platens which operate under vacuum support, and/or platens which operate with increased stiffness (compared with platens which are not joined to an additional part). In such cases, the platen or multi-platen may be considered to comprise the additional part (e.g. vacuum chamber) to which is joined. A platen or multi-platen which is attached to an additional part (e.g. a vacuum chamber) will perform the same way as a platen or multi-platen which is not attached to an additional part (e.g. without attachment to a vacuum chamber), but the platen attached to an additional part will have higher stiffness than a platen or multi-platen which is not attached to an additional part.

To ensure the contact between the multi-platen 150 and the beam 114, in this example, six springs/hooks (biased attaching members) 110a, 110b, 110c, 112a, 112b, 112c per platen module 100 are present. Such platens 100 may in some examples be formed from a single component with the hooks 120, 122 integral with the body of the platen 100. This means that features of the platen 100 providing accurate platen positioning and media support are made from the same part of the mould, which allows for simpler manufacturing due to reduced post-processing of the platen 100 and the possibility of assembly without using additional fixing parts (e.g. screws).

The at least three biased attaching members 110a, 110b, 110c, 112a, 112b, 112c of each of the two opposing long edges 106a, 106b act to bias the platen 110 towards a structural support 114 to form a flat platen surface 116 against the structural support 114 when the platen 100 is installed in a printer or printer assembly. “Flat” in some examples means an overall deviation away from a zero position of 0.1 mm along a 237.5 mm length platen in the print zone. FIGS. 3 and 4 each show a platen 100 installed in a printer 200 according to example implementations. The platen 100 in this example is secured with hook shapes 120, 122 against a flat reference 114 in the beam. Each spring 124, 126 in this example provides a biasing member and acts to directly apply force into its corresponding hook 120, 122 to avoid local bending deformations in the platen 100. Each hook and spring pair 120, 124 and 122, 126 may be considered to be a biased attaching member 110, 112.

In the examples of FIGS. 3 and 4, the platen 100 may be described as comprising biased attaching members 110, 112. Each of the biased attaching members 110, 112 comprise a hook attaching portion 120, 122 to attach to the platen 100 in a printer 200, and a spring biasing portion 124, 126 to bias the platen 100 towards the structural support 114.

In the examples of FIGS. 3 and 4, the platen 100 may be described as comprising biased attaching members 110, 112, wherein each of the biased attaching members 110, 112 comprise an attaching member portion 120, 122 integrally formed with the platen 100, and a biasing portion 124, 126 to operate with the attaching member portion 120, 122 to bias the platen 100 towards the structural support 114.

FIG. 4 shows a platen 100 installed in a printer 200 with a locking mechanism 128 according to example implementations. The platen 100 and locking mechanism 128 to lock the platen 100 into a fixed position in a printer may be considered to be a printer assembly. In such examples, following securing the platen 100 in the printer 200 using the attachment members 110, 112, the platen 100 may be locked with the locking mechanism 128 to avoid unexpected movements of the platen 100, or platen dislodging.

In some examples, the platen 100 and a structural support 114 may be considered a printer assembly. In some examples, the structural support 114 may be a closed profile beam, and in other examples it may be an open profile beam. Additional performance may be achieved when the beam profile is closed (e.g. in an “O” shape, as opposed to an open beam profile, e.g. a “T” shape), with an additional part (locking mechanism 128) clamping the platen 100 (or multi-platen 150 in a multi-platen system) against a flat surface (e.g. a structural beam 114). The additional performance may be that improved flatness is achieved (i.e. reduced bending deviation of the platen in the long dimension) when a closed profile beam is used. The platen will perform in the same way independently of the beam being open or closed profile, but the overall flatness of the platen against the beam will be higher with a closed beam because a closed profile beam will likely have a flatter surface than an open profile beam.

In some examples, the structural support 114 may be a metal beam, such as a sheet metal beam. The biased attaching members 110, 112 of the platen 110 in such an example act to attach to a flat reference of the structural support 114 to bias the platen 110 towards the structural support 114.

The examples of FIGS. 3 and 4 show printer assemblies which operate under vacuum. Platens 100 discussed herein may be used in both vacuum-operating printers and non-vacuum-operating printers.

FIG. 5 shows a calculated deformation of a platen 500 according to example implementations. Examples disclosed herein allow for platen deformations in the long dimension (shown as the x axis 502 in the graph) which are corrected for by assembly of the platen in the printer (due to fitting the platen in place using the biased attaching members).

FIG. 5 shows a model calculated for a platen with a long dimension of 237.5 mm (9.35″), as shown by the extension of the long dimension of the platen from −118.75 mm to +118.75 mm in the X direction/along the X axis 502. The modelled platen has a 1 mm bow 506 when in its original shape (i.e. prior to installation in a printer). This is shown as an overall deformation in the Z axis 504 from a Z position of −1 mm at the short edges of the platen to a Z position of −0 mm in the centre of the long dimension of the platen. The assembled platen shape has a 0.1 mm straightness 508, shown by the deviation in the Z-direction of 0.1 mm overall (a small deviation in the +Z direction and larger deviation in the −Z direction, mainly at the ends of the platen at −118.75 mm to +118.75 mm, giving a total Z-direction deviation of 0.1 mm).

The platen of claim 1, wherein the at least three biased attaching members of each of the two opposing long edges 106a, 106b are to bias the platen towards a structural support to form a flat platen surface against the structural support.

Platens disclosed herein may be used in both vacuum assisted printing systems, and without vacuum assistance. Platens disclosed herein may be used with accessories such as ink collectors. Platens disclosed herein are replaceable by a (e.g. non-expert) user, by unlocking any additional locking mechanism and unfastening the biased attaching members (e.g. unhooking hook attachment members). There is no need to unscrew any part, which can be fiddly and difficult.

Platens disclosed herein may provide short dimension straightness, achieved due to platen stiffness in the short dimension (e.g. by means of ribs present in the platen design). Platens disclosed herein may allow for long dimension deformation and warpage in the platen, thereby providing a profile with higher flexibility in long dimension for good conformation to the beam (flat reference). Shape control of the warpage, and in the long dimension, of the platen, may be achieved by means of different biased attachment members, such as hooks which are spring loaded against the reference from the structure. To minimize tolerance variability, the hook and the media surface may be provided from the same mould cavity.

Platens and printer assemblies with a platen as disclosed herein may allow for adoption of the platen to the structural beam shape by virtue of the difference in stiffness along the long and short dimensions of the platen and the fixing components described. Tolerance errors may be reduced and manufacturing process variability effects may also be reduced by platens disclosed herein with attaching members integral with the platen body as opposed to using additional screw fillings to fix the platen into the printer. For example, spring-loaded hooks may be used to allow the platen to follow the structural beam shape. As functional dimensions of the platen are obtained from the same part of the injection mold, dimensions tolerance errors may be reduced.

1. A platen, the platen having a first dimension and a second dimension, the first dimension being perpendicular to the second dimension, and having two opposing long edges along the first dimension and two opposing short edges along the second dimension, wherein:
the platen has a higher stiffness in the direction of the second dimension than in the direction of the first dimension; and
each of the two opposing long edges has at least three biased attaching members spaced therealong to bias the platen towards a structural support.

2. The platen of claim 1, wherein the at least three biased attaching members of each of the two opposing long edges are to bias the platen towards a structural support to form a flat platen surface against the structural support.

3. The platen of claim 1, wherein the platen is made of an elastic material.

4. The platen of claim 1, wherein each of the biased attaching members comprise:
a hook attaching portion to attach to the platen in a printer; and;
a spring biasing portion to bias the platen towards the structural support.

5. The platen of claim 1, wherein each of the biased attaching members comprise:
an attaching member portion integrally formed with the platen; and
a biasing portion to operate with the attaching member portion to bias the platen towards the structural support.

6. The platen of claim 1, wherein the platen comprises a number of ribs extending along the second dimension.

7. The platen of claim 6, wherein the number of ribs are formed from platen material, the ribs providing an increased thickness of platen material perpendicular to the first and second dimensions compared to the platen thickness without a rib.

8. The platen of claim 6, wherein the number of ribs are formed from strips of stiffening material fixed to or within the platen.

9. The platen of claim 1, wherein the at least three biased attaching members spaced along a first long edge of the long edges of the platen are located closer to the first long edge than the at least three biased attaching members along a second opposing long edge of the long edges of the platen are located from the second opposing long edge.

10. The platen of claim 1, wherein the stiffness along the second dimension is at least five times greater than the stiffness along the first dimension.

11. The platen of claim 1, wherein the stiffness along the first dimension is less than 48 Nm².

12. The platen of claim 1, wherein the stiffness along the second dimension is at least 240 Nm².

13. A platen assembly comprising a plurality of platens according to claim 1, the plurality of platens arranged, with a short edge of a first of the plurality of platens abutting a short edge of a further of the plurality of the plurality of platens, along the first dimension.

14. A printer assembly comprising:
a platen of any preceding claim; and
a locking mechanism to lock the platen into a fixed position in a printer.

15. A printer comprising the platen, the platen assembly, or the printer assembly, of any preceding claim.
